(19) United States
(12) Patent Application Publication
(10) Pub. No.: US 2008/0265725 A1
(43) Pub. Date: Oct. 30, 2008

(54) CART AND METHOD FOR FURNITURE MANUFACTURE

(75) Inventors: Michael Ruch, Cornelius, NC (US); Patrick Ramey, Taylorsville, NC (US); Michael Watts, Tupelo, MS (US); Craig Larsen, Charlotte, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Industrial Timber

(21) Appl. No.: 11/741,072

(22) Filed: Apr. 27, 2007

(51) Int. Cl. B62B 11/00

(52) U.S. Cl. 312/249.9

(57) ABSTRACT

There is provided a cart and method for manufacturing wood furniture assemblies, such as wood frames for couches and other upholstered furniture. The method includes cutting stock wood at a cutting location to predetermined dimensions to form wood frame members of a plurality of different configurations. A plurality of kits of the wood frame members are selectively disposed on a wheeled cart at the cutting location, each kit including each of a plurality of wood frame members for assembling one furniture frame assembly. The cart is then transported with the kits of the wood frame members to an assembly location remote from the cutting location. The cart can generally include first and second cargo portions that are supported by a wheeled support frame. The cargo portions define horizontal and vertical compartments for receiving all of the wood frame members for assembling a plurality of the wood furniture frame assemblies.

### BACKGROUND OF THE INVENTION

1) Field of the Invention

The present invention relates to the manufacture of wood furniture frame assemblies and, more particularly, to a cart and method for manufacturing such wood furniture assemblies.

2) Description of Related Art

A conventional piece of upholstered furniture, such as a couch or chair, includes a frame assembly that supports cushioning material and a covering of upholstery. The frame assembly can be formed of wood, typically multiple wooden members that are nailed, screwed, or otherwise fastened together to achieve a desired configuration. Thereafter, the furniture frame assembly is upholstered by securing springs and/or cushioning and at least partially covering the frame assembly with the upholstery.

The configuration of the wood furniture frame assembly affects the final configuration of the finished piece of furniture and, therefore, the frame assembly is typically configured specifically for a particular finished piece of furniture. In other words, a variety of different wood frame assemblies must be manufactured in order to manufacture different pieces of upholstered furniture. Further, the frame assemblies require wood frame members of various different sizes and shapes. These wood frame members are produced by cutting stock pieces of wood to the necessary sizes and shapes.

In one conventional process for manufacturing the frame members for such furniture frame assemblies, stock pieces of wood are cut to the dimensions of various frame members in large numbers and stored in a large warehouse until required for assembly of a particular type of frame assembly. Because the frame members are produced in large quantities, the unit price for each member can be reduced and the time for manufacture of each frame member is also reduced. However, the storage of the frame members adds to the cost of manufacture, and large numbers of stocked frame members can potentially be rendered obsolete if the manufacture of a particular frame assembly is terminated.

In some cases, the frame members for such furniture assemblies are manufactured at a location that is remote from the location where the upholstery is to be performed. The frame members can be assembled at the same location as the manufacture of the frame members, but the subsequent transport of the frame assemblies is relatively expensive due to the large size of the assemblies. On the other hand, unassembled frame members are sometimes delivered to the upholstery location. In that case, a large number of similar frame members are bundled on a pallet, and pallets with the necessary different frame members for the frame assemblies are sent to the upholstery location. Fork lifts are used to move the pallets, thereby increasing the noise, danger, and expense for the manufacture of the frame members. Additionally, the use of pallets and fork lifts in the manufacture of the frame members further increases the size requirements for the facility and, hence, the cost.

Thus, there exists a need for improved devices and methods for furniture manufacture and, in particular, in the manufacture of the wood frame members and wood frame assemblies for upholstered furniture.

### BRIEF SUMMARY OF THE INVENTION

According to one embodiment, the present invention provides a method for manufacturing a furniture frame assembly. The method include cutting stock wood at a cutting location to predetermined dimensions to form wood frame members of a plurality of different configurations, such as different rectangular sizes. A plurality of kits of the wood frame members are selectively disposed on a wheeled cart at the cutting location. Each kit includes all of the wood frame members for assembling one furniture frame assembly. The cart is transported with the kits of the wood frame members to an assembly location remote from the cutting location, where the frame members of each kit can be assembled to form one of the furniture frame assemblies.

After being cut, the wood frame members can be disposed in a plurality of bins according to size so that each bin receives wood frame members of a predetermined size. The wood frame members for each kit can then be removed from a plurality of the bins and disposed into respective compartments defined by the cart. Each frame member can be inserted into one of the bins from a first end of the bin, and then removed from the bin from a second, opposite end of the bin. The bins can be disposed at the cutting location in a wall formation between a cutting machine and the cart, and first and second operators positioned on opposite sides of the bins can simultaneously perform the inserting and removing of the frame members, respectively. Further, the stock wood can be cut to select sizes according to the number of frame members in each bin so that a minimum inventory of each size of frame member is maintained. In some cases, some of the frame members can be cut to a plurality of rectangular sizes using a first cutting machine, and other frame members can be cut to a plurality of nonrectangular shapes using a second cutting machine.

The cart for transporting the wood frame members generally includes a first cargo portion, a second cargo portion, and a wheeled support frame. The first cargo portion has a plurality of planar horizontal support members and a plurality of vertical divider members disposed between the support members so that the first cargo portion defines a plurality of horizontal compartments. Each horizontal compartment is accessible through a vertical opening and configured to retain a plurality of the wood frame members disposed generally horizontally therein. The first cargo portion can define apertures on a side opposite the vertical openings of the horizontal compartments and adjacent to and above each of the planar horizontal support members to facilitate the cleaning of the horizontal compartments. The second cargo portion is disposed at one end of the first cargo portion and has at least one planar horizontal support member and a plurality of vertical divider members disposed above the support member so that the second cargo portion defines a plurality of vertical compartments. Each vertical compartment is accessible through a horizontal opening and configured to retain a plurality of the wood frame members disposed generally vertically therein. Vertical dividers extending from the first cargo portion can be also disposed above the dividers of the second cargo portion. The wheeled support frame, which is disposed under the cargo portions and configured to support the cargo portions, has a plurality of wheels connected thereto so that the cart is configured to be rollably transported on the wheels. The horizontal and vertical compartments of the cart are configured to receive all of the frame members for assembling a plurality of the furniture frame assemblies. For example, a plurality kits of the wood frame members can be provided on the cart. Each kit includes each of a plurality of wood frame members for assembling one furniture frame assembly. The frame members can be disposed in the compartments according to the size of the members so that frame members of similar size are disposed together in a respective compartment of the cart.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective view illustrating a conventional wood furniture frame assembly that includes a plurality of wood frame members;

FIG. 2 is a plan view schematically illustrating facilities for manufacturing furniture frame assemblies according to one embodiment of the present invention;

FIG. 3 is a perspective view illustrating a bin structure for receiving the frame members according to one embodiment of the present invention;

FIG. 4 is a perspective view illustrating a cart for transporting wood frame members during manufacture of furniture frame assemblies according to one embodiment of the present invention;

FIGS. 5 and 6 are elevation views illustrating the cart of FIG. 4, shown in unloaded and loaded configurations, respectively;

FIG. 7 is a partial elevation view of the cart of FIG. 4, illustrating a list in a list holder attached to the cart; and

FIG. 8 is a flow diagram schematically illustrating the operations of a method for manufacturing a furniture frame assembly according to one embodiment of the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

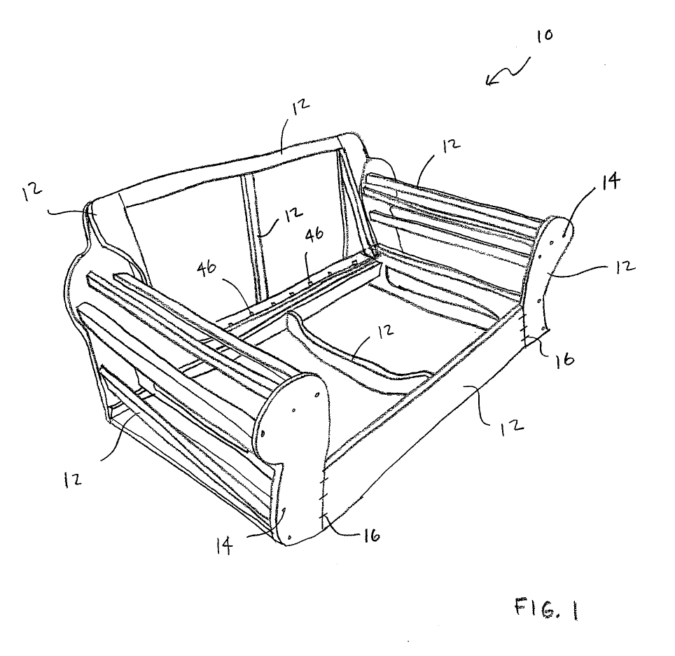

Referring now to the figures and, in particular, to FIG. 1, there is shown a conventional wood furniture frame assembly 10 for use in the manufacture of a variety of types of furniture, typically upholstered furniture such as couches, chairs, and the like. In particular, the frame assembly 10 of FIG. 1 is configured for manufacturing an upholstered couch, but it is appreciated that similar frame assemblies 10 of other configurations can be used to manufacture other furniture. The furniture frame assembly 10 includes a plurality of wood frame members 12 of different sizes and configurations. The frame members 12 can be formed of various types of wood, including solid hardwoods and engineered woods such as plywood and oriented strand board (OMB). The frame members 12 are assembled to form the frame assembly 10, e.g., by nailing, screwing, stapling, gluing, or otherwise securing the various frame members 12 in the desired configuration. In the embodiment of FIG. 1, the frame members 12 of the assembly 10 are secured by nails 14, staples 16, and adhesive (not shown).

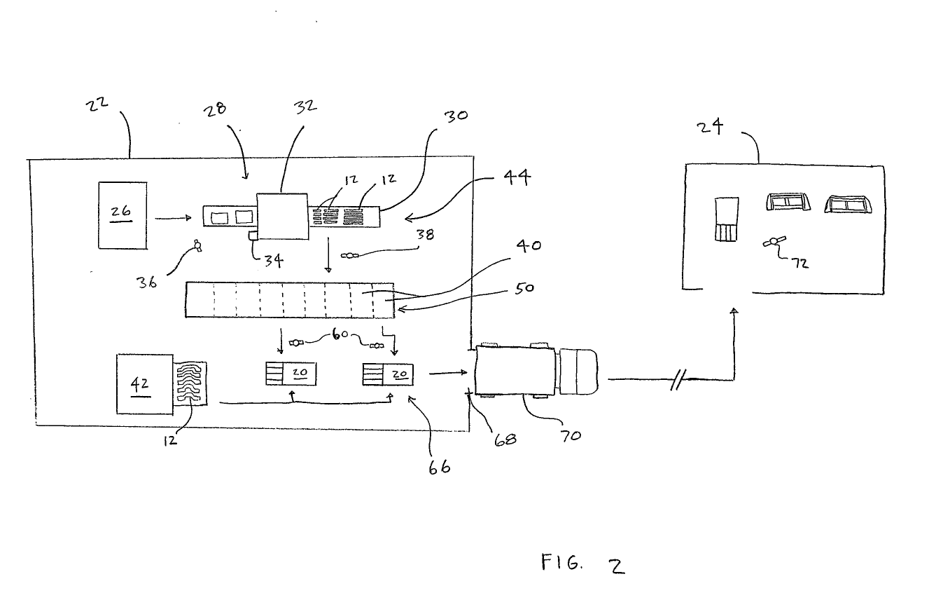

FIG. 2 provides a schematic illustration of facilities for manufacturing the wood frame members 12 and wood furniture frame assemblies 10 according to one embodiment of the present invention. In the illustrated embodiment, the frame members 12 are cut to predetermined sizes and selectively grouped on carts 20 at a first location 22, and then transported to a second location 24 for assembly of the frame members 12. Upholstery of the assemblies 10 can be performed in the second location 24 or at another location. Further, while the cutting and assembly of the frame members 12 are typically performed in different buildings at different, remote locations, it is appreciated that both operations could be performed at a single facility, e.g., at different areas of a single building.

The frame members 12 can be cut from stock wood 26, such as wood boards or sheets of plywood or OSB that are obtained in standard sizes. Such stock wood 26 can be cut to a variety of predetermined configurations having different dimensions as needed for one or more configurations of frame assemblies 10 that are to be manufactured. Cutting can be performed using a variety of cutting machines. As illustrated in FIG. 2, a first cutting machine 28 includes a conveyor 30 for carrying the stock wood 26 through a cutting device 32, which can include a table saw or band saw for cutting the wood longitudinally (e.g., rip cutting) and/or a cross-cutting saw that cuts the wood transversely. The cutting machine 28 can be a programmable device that automatically cuts the stock wood 26 into pieces having particular dimensions. An electronic controller 34 can be used by a human operator 36 to control the machine 28, e.g., by entering characteristics regarding the sizes and/or number of frame members 12 to be cut using a keyboard or other input device. For example, the operator 36 can enter the desired length, width, and thickness dimensions for a rectangular one of the frame members 12, so that the cutting machine 28 then cuts the stock wood 26 into a plurality of the frame members 12, each having a rectangular configuration with the desired dimensions.

In operation, one or more operators 36, 38 can load the stock wood 26 onto the conveyor 30 and unload the frame members 12 from the conveyor 30 after cutting. The cut frame members 12 are then disposed into a plurality of bins 40 located near the first cutting machine 28. In this regard, one or more human operators 38 typically remove the frame members 12 from the conveyor 30 of the cutting machine 28 and place the frame members 12 in appropriate bins 40, though in some cases this operation can be performed automatically by a machine.

In some cases, additional machines can also be provided for cutting some of the frame members 12. In this regard, FIG. 2 illustrates a second cutting machine 42 that is also provided in a cutting area 44 of the first location 22. The second cutting machine 42 can be a router or other device that is configured to cut stock wood 26 to nonrectangular shapes having predetermined dimensions. In particular, the second cutting machine 42 can be configured to cut a plurality of nonrectangular frame members 12 from a single piece of stock wood 26, such as a plywood sheet, and the machine 42 can automatically optimize the cutting of each piece of stock wood 26 to minimize waste. Thus, in some cases, some of the wood frame members 12 for a particular assembly 10 can have generally rectangular shapes cut by the first cutting machine 28, and some of the wood frame members 12 can have nonrectangular shapes cut by the second cutting machine 42. Further, the frame members 12 cut by the second cutting machine 42 can be disposed in the bins 40 and/or on the cart 20 in a manner similar to the handling of the frame members 12 that are cut by the first cutting machine 28.

It is appreciated that other and/or additional cutting machines can be used to cut the frame members 12. Also, the cutting machines can be used in other or additional manners. For example, in some cases, the second cutting machine 42 can be used to cut some rectangular frame members 12, e.g., to make use of available material in a piece of stock wood that is being cut to make nonrectangular frame members 12. Any rectangular frame members 12 cut by the second cutting machine 42 can be disposed in the appropriate bins 40, thereby providing a visual indication to the operator 36 of the first cutting machine 28 of the total inventory of frame members 12, including those frame members 12 cut with the second machine 42.

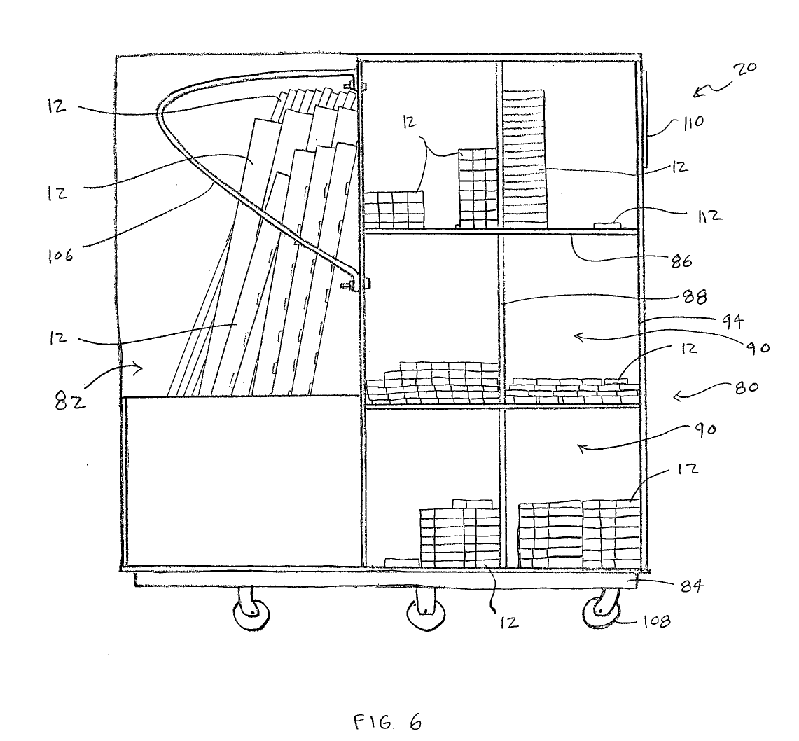

Some or all of the frame members 12 can be further modified before being transported on the carts 20. For example, as shown in FIGS. 1 and 6, hardware can be provided on the frame members 12 before the frame members 12 are transported with the cart 20 to a second location 24 for assembly. The hardware can include connectors 46, such as metal, tab-like connectors 46 that are nailed, screwed, stapled, crimped, adhered, tied, or otherwise attached to one or more of the frame members 12. The connectors 46 can facilitate the subsequent connection of the frame members 12 to one another during assembly and/or the connectors 46 can provide a point of connection for the upholstering of the assembly 10. The connectors 46 can be provided on select frame members 12 before or after the frame members 12 are disposed in the bins 40.

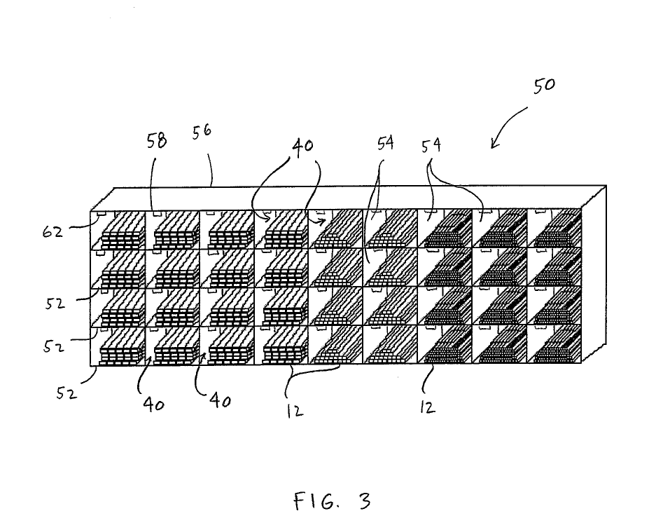

The bins 40 are defined by a bin structure 50 that is constructed in a wall formation. As illustrated in FIG. 3, the bin structure 50 includes a plurality of horizontal support surfaces or shelves 52 with vertical partitions 54 extending between the shelves 52. Thus, each shelf 52 defines a plurality of horizontally successive bins 40, and the bins 40 are disposed at different vertical positions on the various shelves 52. The bins 40 are open on two opposite sides 56, 58 of the bin structure 50. In this way, each bin 40 defines a pass-through configuration, i.e., a configuration open at both opposite ends, such that the interior of the bin 40 can be accessed from both sides 56, 58 so that frame members 12 can be loaded and unloaded simultaneously from the opposite sides 56, 58, as described below. In other words, while one of the operators 38 performs the task of removing the cut frame members 12 from the conveyor 30 of the first cutting machine 28 and placing the frame members 12 into the various bins 40 from the first side 56, one or more different operators 60 can remove the frame members 12 from the second side 58 of the various bins 40, accessing the same or different bins 40 as those being filled by the operator 38 on the first side 56.

Each bin 40 is associated with a particular configuration of frame member 12 and includes a label 62 or other indication of the characteristics of the frame members 12 therein, such as a written sign indicating characteristics such as the material type, the dimensions, and the like. Typical sizes for the frame members 12 are between about 0.25 and 2.5 inches in thickness, 0.5 and 6 inches in width, and 6 and 96 inches in length. For example, one bin 40 may be designated for solid wood frame members 12 that are 0.875 inch thick, 1.75 inches wide, and 33 inches long. Other bins 40 may be designated for frame members 12 of various other configurations, some of which are shown in Table 1, below:

TABLE 1

| Material | Thickness (inches) | Width (inches) | Length (inches) |
|---|---|---|---|
| Solid oak | 0.875 | 1.750 | 8 |
| Solid oak | 0.875 | 1.750 | 20.5 |
| Solid oak | 0.875 | 1.750 | 25.5 |
| Solid oak | 0.875 | 1.750 | 35 |
| Solid oak | 0.875 | 1.375 | 33 |
| Solid oak | 0.875 | 1.375 | 32.625 |
| Solid oak | 0.875 | 1.375 | 32.875 |
| Solid oak | 0.875 | 1.375 | 33.625 |
| Solid oak | 0.875 | 1.375 | 33.75 |
| Solid oak | 0.875 | 1.375 | 36.625 |
| Solid oak | 0.875 | 2.375 | 25.5 |
| Plywood | 0.875 | 2.875 | 24 |
| Plywood | 0.875 | 3.5 | 24 |
| Plywood | 0.875 | 5.4 | 32.625 |
| Plywood | 0.875 | 8.875 | 26 |

Any number of different frame members 12 can be cut and disposed in the different bins 40 as is required for manufacturing particular frame assemblies 10. In some cases, between about 10 and 100 bins 40 can be provided for receiving different frame members 12. At least some of the frame members 12 can be provided in the same sizes but in different materials, such as in plywood as well as solid oak or other solid woods.

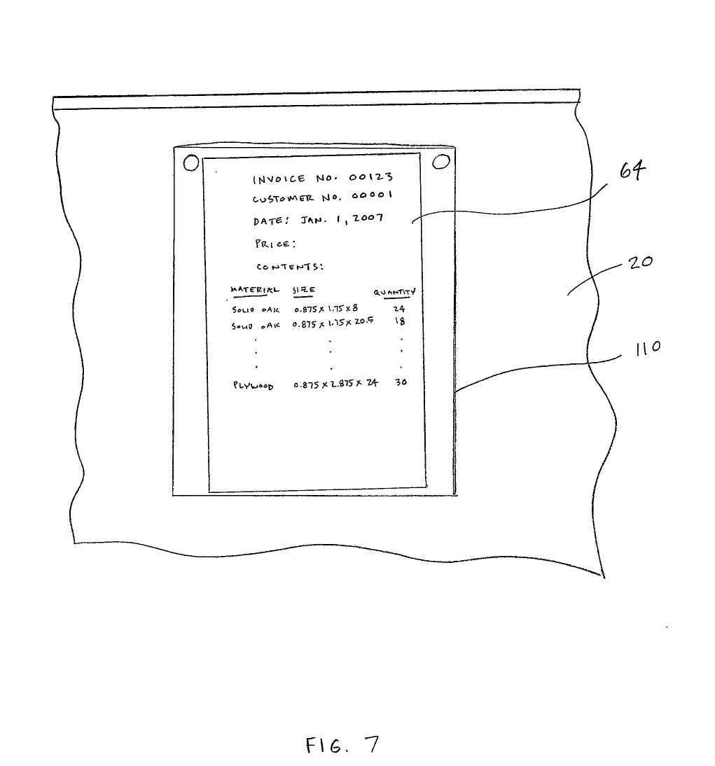

In the embodiment illustrated in FIG. 2, the frame members 12 are disposed in the bins 40 by the operator 38 from the first side 56 of the bin structure 50. While the operator 38 loads the frame members 12 into the bin structure 50, one or more of the operators 60 simultaneously unloads frame members 12 from the other side 58 of the structure 50. The operator 60 removes frame members 12 from the bins 40 as required for forming the furniture frame assemblies 10. While the operator 60 removing the frame members 12 typically selects the frame members 12 for a particular frame assembly 10 according to a written list 64 (FIG. 7), such as an invoice for a particular customer or order, the operator 36 controlling the cutting machine(s) 28, 42 typically does not need to refer to any written lists or invoices to determine what configuration of frame members 12 need to be cut. Instead, the removal of the frame members 12 from the bins 40 and, hence, the number of frame members 12 in the bins 40 at any given time, provides a visual indication to the operator 36 of the cutting machine(s) 28, 42 regarding the demand for different configurations of frame members 12 and which configurations are most needed and should be cut in the immediate future. In other words, the operator 36 can simply cut the stock wood 26 to select sizes according to the number of frame members 12 in each bin 40, i.e., by visually monitoring the number of frame members 12 in each bin 40 and cutting the stock wood 26 to sizes as required for refilling any bins 40 that have low inventories relative to the other bins 40 or are empty. Thus, the task of the operator 36 is simplified, thereby potentially reducing the occurrence of mistakes, reducing the training and skill required for the operator 36, and increasing the efficiency of the cutting operation.

As illustrated in FIG. 2, the bin structure 50 is located between the cutting area 44 cutting machine 28 and an area 66 for receiving one or more of the wheeled carts 20. The operator 60 removes the frame members 12 from the side 58 of the bin structure 50 according to the list 64 such that the all of the frame members 12 required for manufacturing at least one of the frame assemblies 10 are provided on a single one of the carts 20. The list 64 typically includes a number of entries, each entry indicating the characteristics of one of the frame members 12 (such as the material and dimensions of the frame member) and a quantity that indicates how many of the frame members 12 are required for manufacturing one or more of the frame assemblies 10. Referring to the labels 62 on the various bins 40, the operator 60 selects frame members 12 from the bins 40 that correspond to the frame members 12 identified on the list 64, removing a quantity as indicated by the list 64. The operator 60 disposes the frame members 12 on one of the carts 20 so that the frame members 12 can be transported on the cart 20 to the second location 24 for assembly.

In some cases, the locations 22, 24 for the cutting of the frame members 12 and the assembly of the frame assemblies 10 may be proximate one another so that the carts 20 can be transported between the two locations 22, 24 by simply wheeling the carts 20. It is anticipated, however, the first and second locations 22, 24 will normally be remote from one another, typically in different buildings such that the carts 20 must be transported on trucks or otherwise between the locations 22, 24. As illustrated in FIG. 2, the carts 20 can be pushed or pulled by human operators 60 to a building dock 68 at the first location 22 where the carts 20 are loaded onto a truck 70 that then transports the carts 20 to the second location 24. At the second location 24, the carts 20 can again be transported under human power to a particular position for temporary storage and/or assembly.

Each cart 20 includes all of the wood frame members 12 that are required for one or more of the frame assemblies 10. Thus, as shown in FIG. 2, an assembler 72 can assemble one or more of the frame assemblies 10 using the frame members 12 on one of the carts 20 without requiring the addition of any other wood frame members 12. Relative to conventional methods in which the various frame members 12 for a particular furniture figure assembly are provided on multiple pallets or other transport containers, the inclusion of all necessary frame members 12 on a single cart 20 potentially provides a significant improvement in efficiency during assembly by providing convenient and organized access to the assembly 72 of all the frame members 12 for an assembly 10 on a single cart 20. Further, unlike heavy pallets or other containers that typically require forklifts for transport, the carts 20 can easily be wheeled, typically under human power. This offers a significant reduction in forklift traffic at the first and second locations 22, 24. In fact, in some cases, one or both of the locations 22, 24 can operate without any forklifts for moving the frame members 12, thereby potentially reducing noise, danger, and expense associated with the manufacture of the assemblies 10 and reducing the size requirements for the facilities.

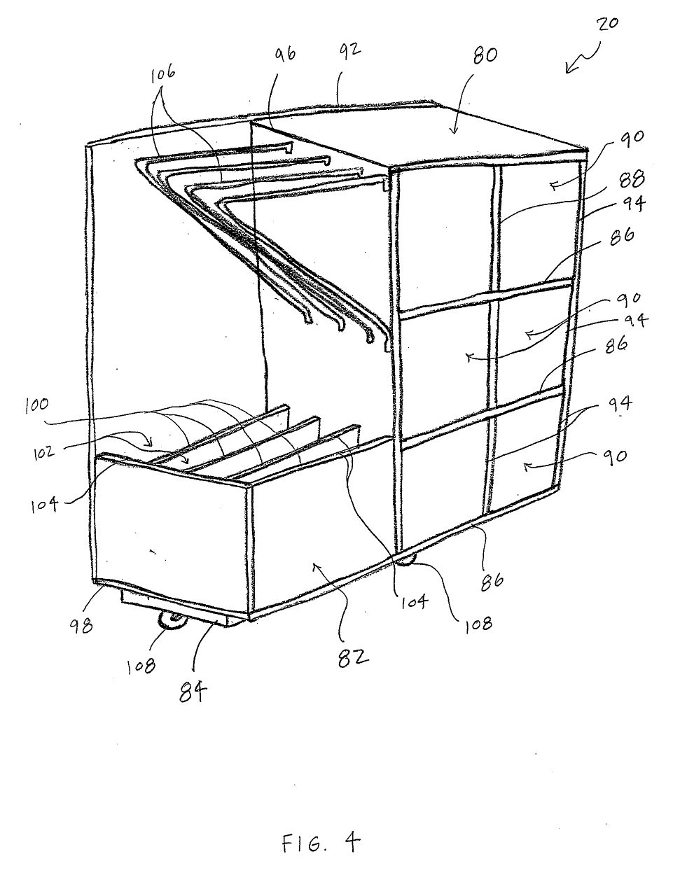

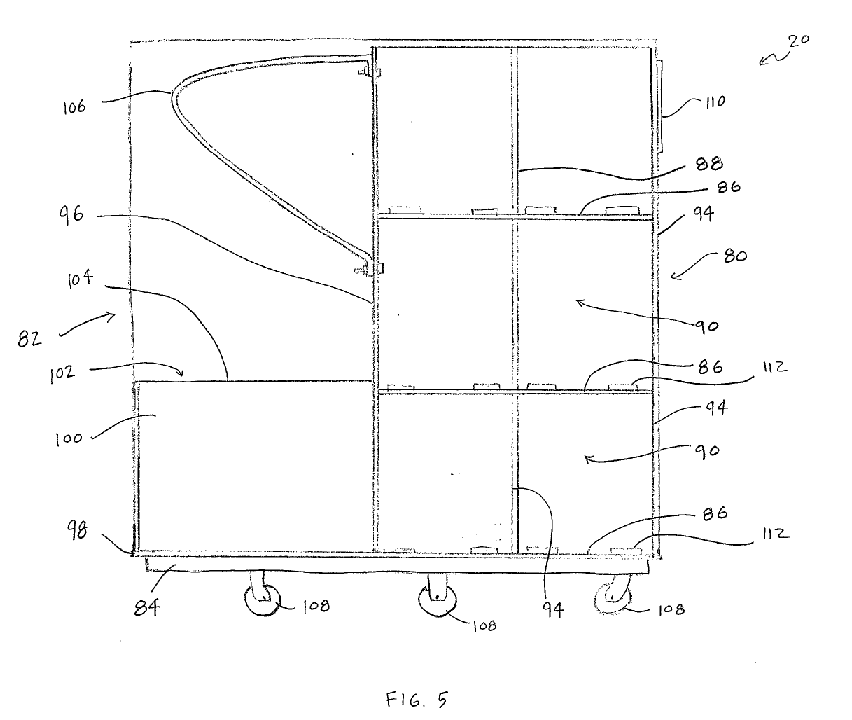

The cart 20 according to one embodiment of the present invention is shown individually in FIGS. 4 and 5. As illustrated, the cart 20 includes first and second cargo portions 80, 82 that are supported by a wheeled support frame 84. The first cargo portion 80 is configured to receive frame members 12 in a generally horizontally disposed configuration, and the second cargo portion 82 is configured to receive frame members 12 in a generally vertically disposed configuration. For example, the first cargo portion 80 can include planar horizontal support members 86, each of which defines a horizontal support surface for receiving the frame members 12. A plurality of vertical divider members 88 are disposed between the support members 86 to define several horizontal compartments 90. A side member 92 substantially closes one side of the compartments 90, and each horizontal compartment 90 is accessible through a vertical opening 94 at the opposite side. Thus, frame members 12 disposed within the compartments 90 are retained therein during transport.

The second cargo portion 82 is provided at an end 96 of the first cargo portion 80 so that the two cargo portions 80, 82 are adjacent one another. The second cargo portion 82 includes a planar horizontal support member 98 and a plurality of vertical divider members 100 disposed above the support member 98 to define several vertical compartments 102. Each vertical compartment 102 is accessible through a horizontal opening 104 at its top, and the compartments 102 are configured to retain frame members 12 that are disposed generally vertically therein. That is, one end of each frame member 12 can be disposed in one of the vertical compartments 102 so that the opposite end of the frame member 12 is leaned against the first cargo portion 80 and/or one or more vertical dividers 106 disposed above the vertical compartments 102. The vertical dividers 106, which can be formed of wood boards or rigid metal as shown that extend from the first cargo portion 80, can be disposed directly above the vertical divider members 100 of the vertical compartments 102.

The wheeled support frame 84 is disposed under the cargo portions 80, 82 and configured to support the cargo portions 80, 82. While the cargo portions 80, 82 of the cart 20 can be formed of wood, such as plywood, the support frame 84 is typically formed of metal, such as steel channels, tubes, or angles. The support frame 84 has a plurality of wheels 108 connected thereto so that the cart 20 can be rollably transported on the wheels 108.

FIG. 6 illustrates the cart 20 with a plurality of kits of the wood frame members 12. Each kit includes all of the wood frame members 12 required for assembling a single one of the furniture frame assemblies 10, such as the assembly shown in FIG. 1. The frame members 12 can be arranged in the various compartments of the cart 20 according to the material, size, and/or configuration of the members 12, as illustrated in FIG. 6. For example, all of the frame members 12 of a particular size, shape, and/or material can be disposed in a single one of the compartments 90, 102, and each compartment 90, 102 can include only frame members 12 of one size, shape, and/or material. In some cases, multiple configurations of frame members 12 can be disposed in a single compartment 90, 102, e.g., on opposite sides of the compartment 90, 102 so that the different members 12 can be easily distinguished. Relatively long frame members 12 can be disposed in the vertical compartments 102 and relatively short frame members 12 can be disposed in the horizontal compartments 90.

As illustrated in FIG. 7, the cart 20 can include a list holder 110 configured to hold the list 64 of the frame members 12 that are to be provided on the cart 20. For example, the holder 110 can be a transparent pocket or folder secured to the cart 20 so that the operator 60 can easily access the list 64 while selecting the members 12 to be loaded onto the cart 20. In some cases, the list 64 can serve as an invoice that is delivered with the cart 20 to the second location 24 for reference by the assembler 72.

The cart 20 can also define apertures 112 in the various compartments 90, 102 for use in cleaning or other maintenance of the cart 20. For example, as shown in FIG. 5, the first cargo portion 80 defines a plurality of apertures 112 on a side opposite the vertical openings 94 of the horizontal compartments 90. Each aperture 112 can be adjacent to and above one of the planar horizontal support members 86. During cleaning the apertures 112 can be used to remove sawdust or other debris in the compartments 90. In particular, sawdust can be pushed or blown toward the apertures 112 and removed therefrom. Alternatively, air can be blown into the compartments 90 through the apertures 112, e.g., using an air compressor, so that any debris in the compartments 90 is movedout of the compartments 90 through the vertical openings 94 by the air. Similarly, apertures can also be provided at the bottom of the vertical compartments 102.

In one typical method of the present invention, the wood frame members 12 are disposed in the bins 40 according to the size of each member 12, i.e., so that each bin 40 receives wood frame members 12 of a predetermined size. Thereafter, the wood frame members 12 can be selectively removed from the bins 40 to form a plurality of kits of the wood frame members 12. That is, an operator 60 can select and remove the wood frame members 12 for each kit from a plurality of the bins 40. The operator 60 disposes the wood frame members 12 for each kit into respective compartments defined by the cart 20, such as by placing all of the frame members 12 of a particular configuration into one of the compartments 90, 102 of the cart 20 so that the frame members 12 on the cart 20 are organized by size and can be easily located during assembly. Thereafter, the kits are transported on the cart 20 for assembly, e.g., at the second assembly location 24.

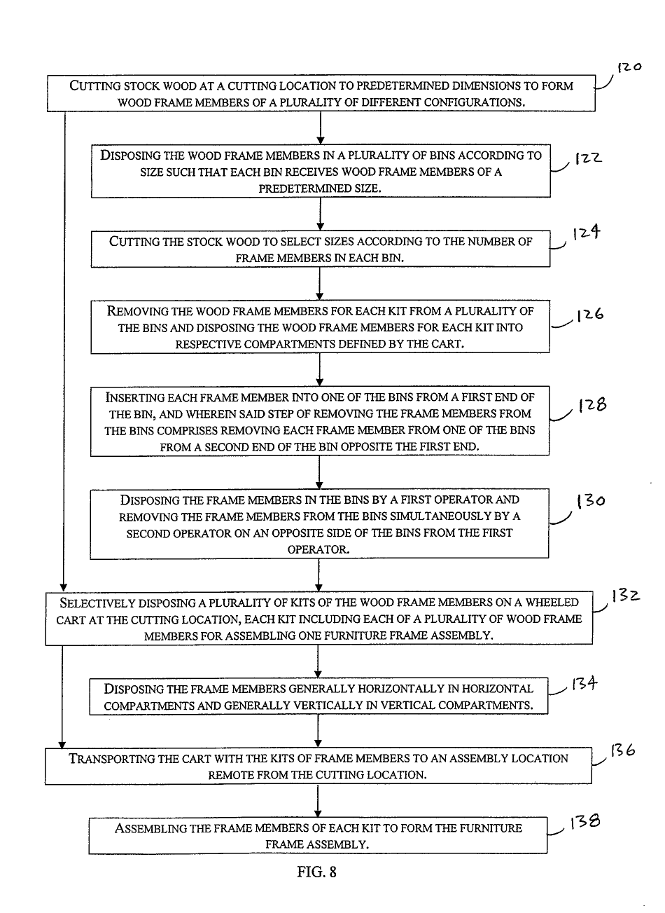

The operations for manufacturing a furniture frame assembly 10 according to one embodiment of the present invention are further illustrated schematically in the flow diagram of FIG. 8. It is appreciated that the method can include other operations, and/or some of the illustrated operations can be omitted. As illustrated, stock wood 26 is cut at a first location 22, i.e., a cutting location, to predetermined dimensions to form wood frame members 12 of a plurality of different configurations. See Block 120. At least some of the stock wood 26 is typically cut to a plurality of rectangular sizes. Some of the frame members 12 can be cut to a plurality of nonrectangular shapes and, in some cases, the rectangular and nonrectangular members 12 can be cut on different cutting machines 28, 42. The wood frame members 12 can be disposed in a plurality of bins 40 according to size so that each bin 40 receives wood frame members 12 of a predetermined size. See Block 122. The stock wood 26 can be cut to select sizes according to the number of frame members 12 in each bin, e.g., to maintain a minimum number of the frame members 12 in each of the bins 40 and, hence, a minimum number of each of the different configurations of frame members 12. See Block 124. The wood frame members 12 for each of a plurality of kits are removed from a plurality of the bins 40 and disposed into respective compartments defined by the cart 20. See Block 126. In particular, each frame member 12 can be inserted into one of the bins 40 from a first end of the bin 40 and removed from a second end of the bin 40 opposite the first end. See Block 128. Different operator 38, 60 on opposite sides 56, 58 of the bins 40 can simultaneously perform the inserting and removing of the frame members 12. See Block 130. A plurality of the kits of the wood frame members 12 are disposed on a wheeled cart 20 at the cutting location 22. Each kit includes each of a plurality of wood frame members 12 for assembling one furniture frame assembly 10. See Block 132. For example, the frame members 12 can be disposed generally horizontally in horizontal compartments and generally vertically in vertical compartments of the cart. See Block 134. In some cases, the frame members 12 in the vertical compartments can be disposed between vertical dividers located above the vertical compartments and extending from the horizontal compartments. The cart 20 is transported with the kits of frame members 12 to an assembly location 24 remote from the cutting location 22. See Block 136. Thereafter, the frame members 12 of each kit can be assembled to form a furniture frame assembly 10, e.g., by the assembler 72. See Block 138. In some cases, the assembler 72 can trim the frame members 12, add connectors, or otherwise modify the frame members 12 before or during the assembly. The assembled frame assembly 10 can be upholstered at the assembly location 24, e.g., by the assembler 72, or transported to a different location for upholstery and/or other finishing.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for manufacturing a furniture frame assembly, the method comprising:
cutting stock wood at a cutting location to predetermined dimensions to form wood frame members of a plurality of different configurations;
selectively disposing a plurality of kits of the wood frame members on a wheeled cart at the cutting location, each kit including each of a plurality of wood frame members for assembling one furniture frame assembly; and
transporting the cart with the kits of the wood frame members to an assembly location remote from the cutting location.

2. A method according to claim 1 wherein said cutting step comprising cutting stock wood to a plurality of rectangular sizes.

3. A method according to claim 2, further comprising disposing the wood frame members in a plurality of bins according to size such that each bin receives wood frame members of a predetermined size, and wherein said step of disposing the plurality of kits of the wood frame members comprises removing the wood frame members for each kit from a plurality of the bins and disposing the wood frame members for each kit into respective compartments defined by the cart.

4. A method according to claim 3 wherein said cutting step comprises cutting the stock wood to select sizes according to the number of frame members in the bins.

5. A method according to claim 3 wherein said step of disposing the frame members in the bins comprises inserting each frame member into one of the bins from a first end of the bin, and wherein said step of removing the frame members from the bins comprises removing each frame member from one of the bins from a second end of the bin opposite the first end.

6. A method according to claim 5 wherein said step of disposing the frame members in the bins is performed by a first operator and said step of removing the frame members from the bins is performed simultaneously by a second operator, the bins being disposed at the cutting location in a wall formation between a cutting machine and the cart, and the first and second operators being positioned on opposite sides of the bins.

7. A method according to claim 3, further comprising cutting a portion of the frame members to a plurality of rectangular sizes using a first cutting machine and cutting a second portion of the frame members to a plurality of nonrectangular shapes using a second cutting machine.

8. A method according to claim 1 wherein said step of disposing the frame members on the cart comprises disposing the frame members in a plurality of horizontal compartments and a plurality of vertical compartments, the frame members being disposed generally horizontally in the horizontal compartments and generally vertically in the vertical compartments.

9. A method according to claim 8 wherein said step of disposing the frame members on the cart comprises disposing the frame members in the vertical compartments and between vertical dividers above the vertical compartments and extending from the horizontal compartments.

10. A method according to claim 1, further comprising assembling the frame members of each of the kits on the cart to form the furniture frame assembly.

11. A cart for transporting a plurality of wood frame members during manufacture of furniture frame assemblies, the cart comprising:
a first cargo portion having a plurality of planar horizontal support members and a plurality of vertical divider members disposed between the support members such that the first cargo portion defines a plurality of horizontal compartments, each horizontal compartment accessible through a vertical opening and configured to retain a plurality of the wood frame members disposed generally horizontally therein,
a second cargo portion at one end of the first cargo portion, the second cargo portion having at least one planar horizontal support member and a plurality of vertical divider members disposed above the support member such that the second cargo portion defines a plurality of vertical compartments, each vertical compartment accessible through a horizontal opening and configured to retain a plurality of the wood frame members disposed generally vertically therein;
a wheeled support frame disposed under the cargo portions and configured to support the cargo portions, the support having a plurality of wheels connected thereto such that the cart is configured to be rollably transported on the wheels,
wherein the horizontal and vertical compartments of the cart are configured to receive all of the frame members for assembling a plurality of the furniture frame assemblies.

12. A cart according to claim 11 wherein the first and second cargo portions are formed of wood and the support frame is formed of metal.

13. A cart according to claim 11, further comprising a plurality of vertical dividers extending from the first cargo portion and disposed above the dividers of the second cargo portion.

14. A cart according to claim 11 wherein the first cargo portion defines a plurality of apertures on a side opposite the vertical openings of the horizontal compartments and adjacent to and above each of the planar horizontal support members to facilitate cleaning of the horizontal compartments.

15. A cart according to claim 11, further comprising a plurality kits of the wood frame members, each kit including each of a plurality of wood frame members for assembling one furniture frame assembly, and the frame members being disposed in the compartments according to the size of the members such that frame members of similar size are disposed together in a respective compartment of the cart.
